(19) United States
(12) Patent Application Publication
(10) Pub. No.: US 2005/0030266 A1
(43) Pub. Date: Feb. 10, 2005

(54) Active matrix type display apparatus

(76) Inventor: Hirondo Nakatogawa, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/941,090

(22) Filed: Sep. 15, 2004

Related U.S. Application Data
(63) Continuation of application No. PCT/JP04/06926, filed on May 14, 2004.

(30) Foreign Application Priority Data
May 16, 2003 (JP) 2003-139444

(51) Int. Cl. G09G 3/30

(52) U.S. Cl. 345/76; 315/169.3

(57) ABSTRACT

A plurality of display pixels arranged in a matrix form respectively have a self-luminescent element, a driving transistor which controls an electric current amount made to flow in the self-luminescent element, in accordance with an image signal, and a switch formed of a thin-film transistor and connected between a gate and a drain of the driving transistor. The switch is controlled to be turned on and off by a control signal Sb supplied via a scanning line Cg from a scanning line driving circuit. When the switch is in an ON-state, an electric potential of the control signal is varied in a stepwise manner so as to be close to an electric potential for making the switch be in an OFF-state.

### CROSS-REFERENCE TO RELATED APPLICATIONS

This is a Continuation Application of PCT application No. PCT/JP2004/006926, filed May 14, 2004.

This application is based upon and claims the benefit of priority from the prior Japanese Patent Application No. 2003-139444, filed May 16, 2003, the entire contents of which are incorporated herein by reference.

### BACKGROUND OF THE INVENTION

1. Field of the Invention

The present invention relates to an active matrix type display apparatus wherein a display screen is configured by arranging display pixels including self-luminescent elements such as, for example, an electroluminescence (hereinafter, referred as EL) element in a matrix form.

2. Description of the Related Art

Flat panel type display apparatuses have been broadly used as a display apparatus for a personal computer, an personal digital assistant, a television, or the like. In recent years, as such a flat panel type display apparatus, an active matrix type organic EL display apparatus using a self-luminescent element such as an organic EL element has been given the attention, and the research and development thereof have been actively carried out. The organic EL display apparatus has the following features: it does not require a backlight preventing the organic EL display apparatus from being made to be thin and light-weight, it has a high-speed responsiveness and is suitable for playing-back moving picture, and moreover, it can be used at cold districts as well, because the brightness thereof is not reduced at a low temperature.

Generally, the organic EL display apparatus comprises a plurality of display pixels which are arranged in a plural rows and a plural columns to constitute a display screen, a plurality of scanning lines extending along the respective rows of the display pixels, a plurality of signal conductor lines extending along the respective columns of the display pixels, a scanning line driving circuit for driving the respective scanning lines, a signal conductor line driving circuit for driving the respective signal conductor lines, and the like. Each display pixel includes an organic EL element which is a self-luminescent element, and a pixel circuit for supplying a driving electric current to the organic EL element. The pixel circuit has a pixel switch disposed in the vicinity of the cross positions of the scanning lines and the signal conductor lines, a driving transistor which is connected in series to the organic EL element between a pair of power source lines, and which is formed of a thin-film transistor, and a storage capacitance retaining the gate control voltage of the driving transistor. The pixel switch is made to be conductive in response to a scanning signal supplied from a corresponding scanning line, and acquires an image signal supplied from a corresponding signal conductor line into the pixel circuit. The image signal is written as the gate control voltage into the storage capacitance, and is stored for a predetermined period. The driving transistor supplies an electric current amount corresponding to the gate control voltage written in the storage capacitance to the organic EL element, and the organic EL element is operated to emit light.

The organic EL element has a cathode, an anode, and an emitting layer which is formed of a thin-film including a fluorescent organic compound and provided between the cathode and the anode. The organic EL element generates an exciton by injecting electrons and holes into the emitting layer and recombining those, and emits light due to the light emission generated at the time of deactivation of the exciton. The organic EL element emits light at a brightness corresponding to a supplied electric current amount, and a brightness of about 100 to 100,000 cd/m² can be obtained by even an applied voltage equal to or less than 10 V.

In the organic EL display apparatus, a thin-film transistor serving as the driving transistor is formed of a semiconductor thin-film formed on an insulating substrate such as a glass. Therefore, the characteristics of the driving transistor such as a threshold voltage Vth and a carrier mobility μ depend on the manufacturing process or the like, and easily vary. If there is unevenness in the threshold voltage Vth of the driving transistor, it is difficult to make the organic EL element emit light at an appropriate brightness. Thus, an irregularity in brightness among the plurality of display pixels arises, which causes unevenness in displaying.

For example, in U.S. Pat. No. 6,229,506, there is disclosed a display apparatus in which threshold canceling circuits are provided at all of display pixels in order to avoid the effect due to the irregularity in the threshold voltage Vth. Each threshold canceling circuit is configured such that the control voltage of the driving transistor is initialized by a reset signal supplied in advance of an image signal from the signal conductor line driving circuit. Further, as the other display apparatus, in U.S. Pat. No. 6,373,454, there is proposed a display apparatus in which writing of an image signal is carried out by an electric current signal, and an attempt is made to uniform the brightness of light emission by reducing the effect due to the irregularity in the threshold voltage in the driving transistor.

In the display apparatus described above, the pixel circuit of each display pixel includes a plurality of switches respectively formed of thin-film transistors in order to apply a desired control voltage to the gate of the driving transistor, and controls the respective switches to be turned on and off. However, when these switches are switched from being on to being off, feedthrough voltages ΔVp due to the parasitic capacitance formed between the gates and the sources of the switches are generated. The generated feedthrough voltage is made to flow into the storage capacitance, thereby varying the gate control voltage of the driving transistor.

The filed through voltage ΔVp can be approximately expressed by the following formula.
ΔVp={Cgs/(Cgs+Cs)}×ΔVg

In the formula, respectively, Cgs denotes a parasitic capacitance between the gate and the source of a switch, Cs denotes a storage capacitance, and ΔVg denotes a difference between the ON-state electric potential and the OFF-state electric potential of the gate control signal supplied to the switch.

Usually, an electric potential of the gate control signal supplied to the switch connected to the gate of the driving transistor is set to one level when the switch is in the ON-state. In the display apparatus having such a pixel circuit, the difference ΔVg between the OFF-state electric potential and the ON-state electric potential of the gate control signal is set to be large in order to sufficiently write an image signal, and a feedthrough voltage and the irregularity therein as well are made to be large. In this case, an irregularity arises in the gate control voltage of the driving transistor, and an irregularity in brightness arises among the plurality of display pixels. Such an irregularity in brightness among the display pixels appears as the unevenness in displaying, which deteriorates the quality of displaying.

### BRIEF SUMMARY OF THE INVENTION

The present invention has been contrived in consideration of the above-described problems, and its object is to provide an active matrix type display apparatus in which a generated amount of feedthrough voltage is reduced, and the quality of displaying is improved.

In order to achieve the object, an active matrix type display apparatus according to an aspect of the present invention comprises: a plurality of display pixels arranged in a matrix form, each of the display pixels including a display element operating in accordance with a supplied electric current amount, a driving transistor connected to the display element in series, and a switch which is formed of a thin-film transistor and connected between a gate and a drain of the driving transistor;
a plurality of scanning lines which are provided for respective rows of the display pixels and connected to gates of the switches; and
a scanning line driving circuit which supplies a control signal that controls the switches to be turned on and off via the scanning lines, and which, when the switch is in ON-state, varies an electric potential of the control signal in a stepwise manner so as to be close to an electric potential that makes the switch be in an OFF-state.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a circuit diagram illustrating a configuration of an organic EL display apparatus according to a first embodiment of the present invention.

FIG. 2 is a diagram illustrating an equivalent circuit of display pixels in the organic EL display apparatus.

FIG. 3 is a timing chart for explanation of the operation of the display pixel shown in FIG. 2.

FIG. 4 is a timing chart illustrating a modified example of a control signal for controlling to turn a first switch in the display pixel on and off.

FIG. 5 is a diagram illustrating an equivalent circuit of displayed pixels in an organic EL display apparatus according to a second embodiment of the present invention.

FIG. 6 is a timing chart for explanation of the operation of the display pixel shown in FIG. 5.

### DETAILED DESCRIPTION OF THE INVENTION

Hereinafter, an active matrix type organic EL display apparatus according to a first embodiment of the present invention will be described in detail with reference to the accompanying drawings.

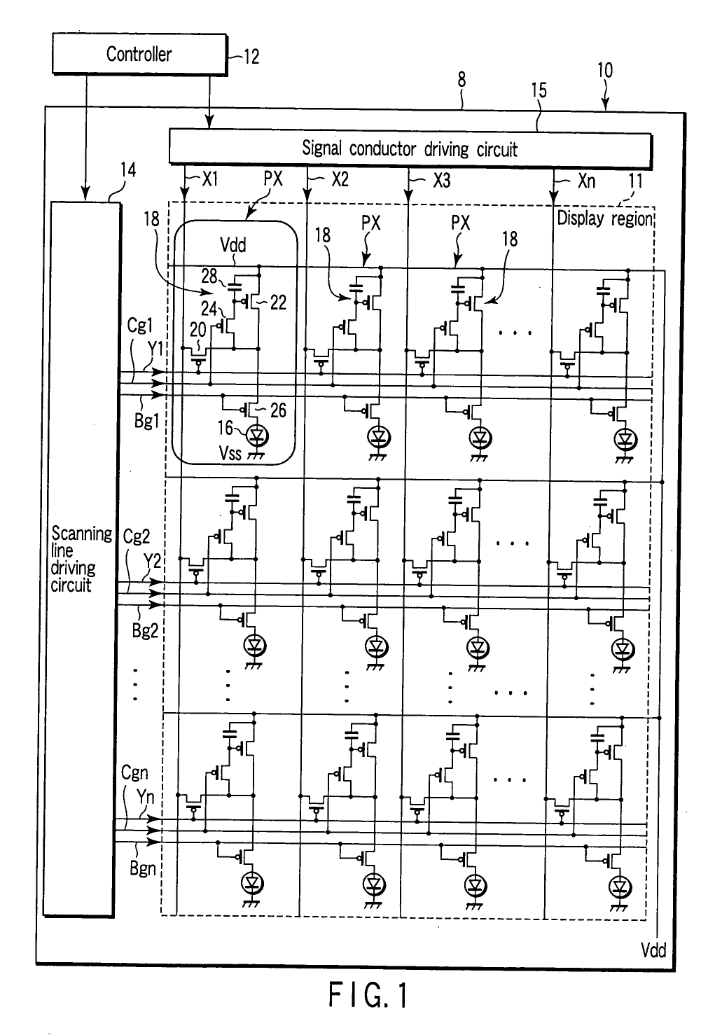

As shown in FIG. 1, the organic EL display apparatus comprises an organic EL panel 10 and a controller 12 for controlling the organic EL panel 10.

The organic EL panel 10 has m×n of display pixels PX which are arranged in a matrix form on a light transmittable insulating substrate 8 such as a glass plate or the like, and which constitute a display region 11, first scanning lines Y (Y1 to Ym), second scanning lines Cg (Cg1 to Cgm), and third scanning lines Bg (Bg1 to Bgm) which are connected to each row of the display pixels, and which are independently provided by m lines, and n of signal conductor lines X (X1 to Xn) respectively connected to each column of the display pixels. The organic EL panel 10 has a scanning line driving circuit 14 for successively driving the first, second, and third scanning lines Y, Cg, and Bg for each row of the display pixels, and a signal conductor line driving circuit 15 for driving a plurality of signal conductor lines X1 to Xn. The driving circuits 14 and 15 are provided on the insulating substrate 8.

Each display pixel PX includes an organic EL element 16 serving as a display element, and a pixel circuit 18 for supplying a driving electric current to the organic EL element. The organic EL element 16 has a cathode, an anode, and an organic emitting layer which includes a fluorescent organic compound and is interposed between the cathode and the anode. The organic EL element 16 generates an exciton by injecting electrons and holes into the organic emitting layer and recombining those, and emits light due to the light emission generated at the time of deactivation of the exciton.

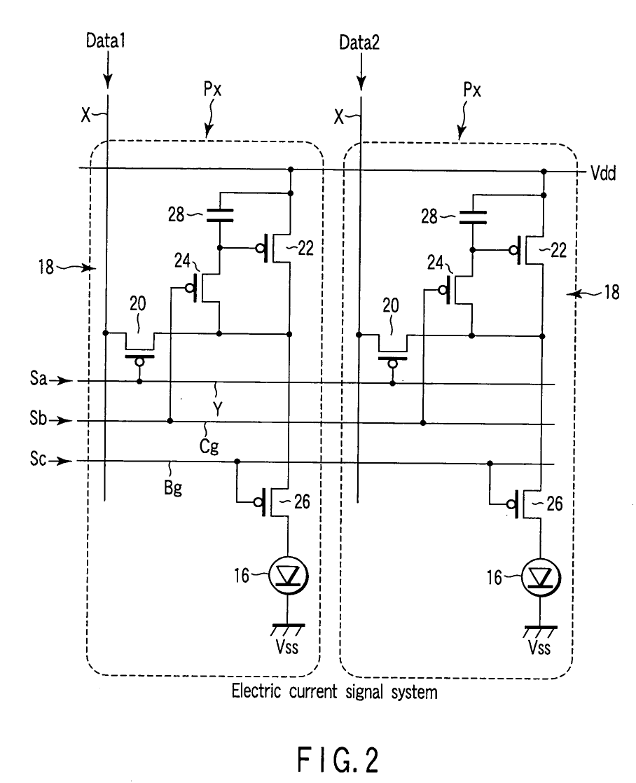

As shown in FIGS. 1 and 2, the pixel circuit 18 is an electric current signal type pixel circuit for controlling light emission of the organic EL element 16 in accordance with an image signal formed from an electric current signal, and has a pixel switch 20, a driving transistor 22, a first switch 24, a second switch 26, and a storage capacitance 28. The pixel switch 20, the driving transistor 22, the first switch 24, and the second switch 26 are configured of the same conductivity type transistors, for example, P-channel type thin-film transistors.

The driving transistor 22 is connected to the organic EL element 16 in series between a first voltage power source Vdd and a second voltage power source Vss, and controls an amount of electric current supplied to the organic EL element in accordance with an image signal. The first and second voltage power sources Vdd and Vss are respectively set to, for example, electric potentials of +10 V and 0 V. The storage capacitance 28 is connected between the source and the gate of the driving transistor 22, and retains a gate control electric potential of the driving transistor 22 determined by the image signal. The pixel switch 20 is connected between the signal conductor line X corresponding thereto and the drain of the driving transistor 22, and the gate thereof is connected to the first scanning line Y according thereto. The pixel switch 20 acquires an image signal into the pixel circuit 18 from the corresponding signal conductor line X in response to a control signal Sa supplied from the first scanning line Y.

The first switch 24 that functions as a switch in the present invention is connected between the drain and the gate of the driving transistor 22, and the gate of the first switch 24 is connected to the second scanning line Cg independent of the first scanning line Y. The first switch 24 is turned on (in a state of being conductive) and off (in a state of being nonconductive) in accordance with a control signal Sb from the second scanning line Cg, and controls the connection and non-connection between the gate and the drain of the driving transistor 22. The second switch 26 is connected between the drain of the driving transistor 22 and one electrode of the organic EL element 16, e.g., the anode, and the gate thereof is connected to a third scanning line Bg independent of the first scanning line Y and the second scanning line Cg. Further, the second switch 26 is turned on and off by a control signal Sc from the third scanning line Bg, and controls the connection and non-connection between the driving transistor 22 and the organic EL element 16.

In the present embodiment, all of the thin-film transistors constituting the pixel circuits are formed by the same process, have the same layer structure, and are thin-film transistors having a top gate structure using polycrystalline silicon as a semiconductor layer. Due to all of the pixel circuits being configured of the same conductivity type thin-film transistors, an increase in the number of manufacturing processes can be suppressed. If the second switch 26 is formed of a conductive thin-film transistor which is different from the pixel switch 20, i.e., an N-channel type thin-film transistor here, the first scanning line Y and the third scanning line Bg may be commonly wired.

The controller 12 shown in FIG. 1 is formed on a printed circuit board arranged at the exterior of the organic EL panel 10, and controls the scanning line driving circuit 14 and the signal conductor line driving circuit 15. The controller 12 receives a digital image signal and a synchronization signal supplied from an external device, generates a vertical scanning control signal for controlling the timing of vertical scanning and a horizontal scanning control signal for controlling the timing of horizontal scanning on the basis of the synchronization signal, and supplies the vertical scanning control signal and the horizontal scanning control signal respectively to the scanning line driving circuit 14 and the signal conductor line driving circuit 15. Further, the controller 12 supplies the digital image signal to the signal conductor line driving circuit 15 synchronously with the horizontal and vertical timings.

The signal conductor line driving circuit 15 converts image signals Data 1 to Data n, which are successively obtained at respective horizontal scanning periods by the control of the horizontal scanning control signal, into analog formats, and supplies the analog signals as current signals to the plurality of signal conductor lines X in parallel. The scanning line driving circuit 14 includes a shift register, an output buffer, or the like. The scanning line driving circuit 14 successively transfers horizontal scanning start pulses supplied from the external device, to the next stage, and supplies three types of control signals, i.e., the control signal Sa, the control signal Sb, and the control signal Sc to the display pixels PX at the respective rows via the output buffer. In accordance therewith, the respective first, second, and third scanning lines Y, Cg, and Bg are driven by the control signal Sa, the control signal Sb, and the control signal Sc at the horizontal scanning periods different from one another.

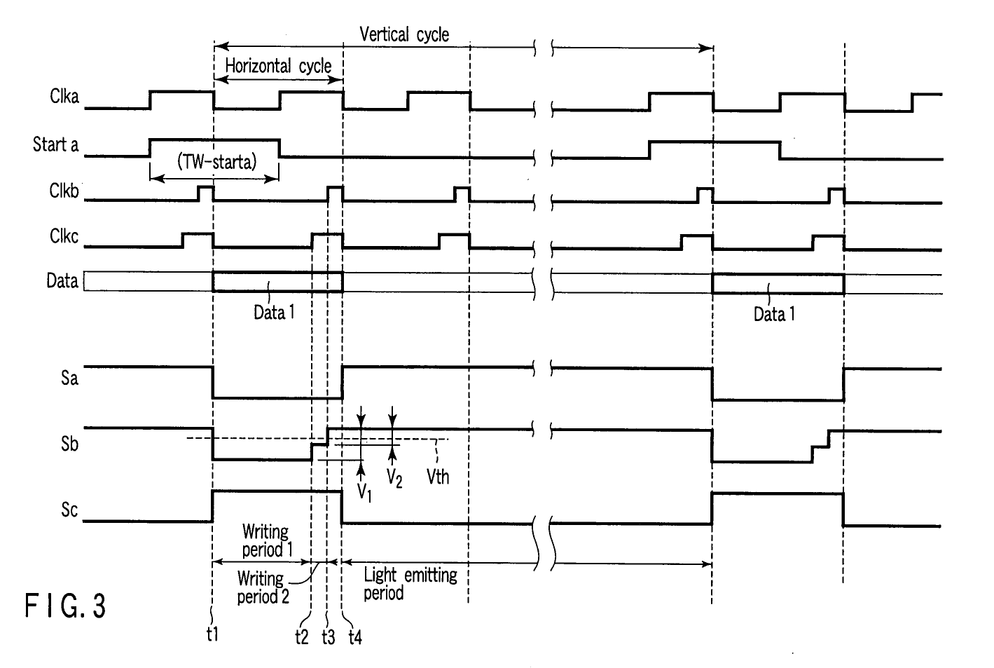

The operation of the pixel circuit 18 based on the output signals of the scanning line driving circuit 14 and the signal conductor line driving circuit 15 will be described with reference to a timing chart shown in FIG. 3.

The scanning line driving circuit 14 generates a pulse having widths (Tw-Starta) corresponding to the respective horizontal scanning periods on the basis of a start signal a (Starta) and a clock a (Clka), and outputs the pulse as the control signal Sa. Further, the scanning line driving circuit 14 generates the control signal Sb on the basis of the control signal Sa, a clock b (Clkb), and a clock c (Clkc), and further generates the control signal Sc by inverting the control signal Sa.

Broadly divided, the operation of the pixel circuit 18 can be divided into three of an image signal writing operation 1, an image signal writing operation 2, and a light emitting operation. At a point in time t1 of FIG. 3, the image signal writing operation 1 is started due to the pixel switch 20, the first switch 24, and the second switch 26 being respectively switched at the same time by control signals such that the pixel switch 20 and the first switch 24 are turned on (in a state of being conductive), the second switch 26 is turned off (in a state of being nonconductive), i.e., here, the control signal Sa and the control signal Sb which are low levels (first electric potential V1), and the control signal Sc which is a high level. For an image signal writing period 1 (t1 to t2), the driving transistor 22 is in a state of a diode connection, and the image signal Data is acquired from the corresponding signal conductor line X via the pixel switch 20. Further, electric current which is substantially equivalent to that of the acquired image signal is made to flow between the source and the drain of the driving transistor 22, and an electric potential between the gate and the source, which corresponds to the electric current amount, is written as a gate control voltage of the driving transistor 22 into the storage capacitance 28.

Next, at a point in time t2, in a state in which the control signal Sa and the control signal Sc are respectively maintained at the low level and the high level, the control signal Sb becomes a second electric potential V2, and the image signal writing operation 2 is continued. The second electric potential V2 of the control signal Sb is the ON-state electric potential maintaining the first switch 24 in the ON-state, and is set to an electric potential between the first electric potential V1 of the control signal Sb and a threshold voltage Vth of the first switch 24. The first electric potential V1 is sufficiently over the threshold voltage Vth of the first switch 24, while it is preferable that the second electric potential V2 is close to the threshold voltage Vth within a range over the threshold voltage Vth. For an image signal writing period 2 (t2 to t3), the first switch 24 is maintained in the ON-state, and the operation of writing the image signal Data is continuously carried out. The image signal writing period 2 (t2 to t3) is set to 0.5 μs or more, for example, 1 to 2 μs.

At a point in time t3, the control signal Sa and the control signal Sc are respectively maintained at the low level and the high level, and the control signal Sb becomes a high level, i.e., an OFF-state electric potential. In accordance therewith, the first switch 24 is turned off, and the image signal writing operation 2 is completed. Thereafter, at a point in time t4, the control signal Sa and the control signal Sc are respectively made to be a high level and a low level, so that the pixel switch 20 and the first switch 24 are turned off, and the second switch 26 is turned on. The driving transistor 22 supplies an electric current amount corresponding to the image signal to the organic EL element 16 by the gate control voltage written in the storage capacitance 28. In accordance therewith, the organic EL element 16 emits light, and light emitting operation is started. Further, the organic EL element 16 maintains the light emitting state until the time when the control signal Sa is supplied again after a period of one frame.

With the organic EL display apparatus constructed as described above, at the time of image signal writing operation, the ON-state electric potential of the control signal Sb is made to be large at the first half of the ON-state (the image signal writing period 1) of the first switch 24, and the ON-state electric potential is made to be small at the second half of the ON-state (the image signal writing period 2). Namely, in the ON-state of the first switch 24, the electric potential of the control signal Sb is varied in a stepwise manner. In the present embodiment, the second electric potential V2 is set between the first electric potential V1 and the OFF-state electric potential of the control signal Sb. When the first switch 24 is switched from being in the ON-state to being in the OFF-state, after the first electric potential V1 is varied to the second electric potential V2 once, at a predetermined period (t2 to t3), the first switch 24 is switched by varying the second electric potential V2 to the OFF-state electric potential.

In this way, by varying the ON-state electric potential of the control signal Sb in a stepwise manner by setting the first and second electric potentials V1 and V2, a difference ΔVg between the second electric potential V2 which is an ON-state electric potential and an OFF-state electric potential can be made to be small as compared with the electric potential difference ΔVg between the ON-state electric potential and the OFF-state electric potential in a case where the ON-state electric potential of the control signal is set to one level. At that time, due to the second electric potential V2 being made to be close to the threshold voltage Vth of the first switch 24, the electric potential difference ΔVg can be made even smaller. Therefore, a feedthrough voltage ΔVp generated at the time of switching the first switch 24 on and off and the irregularity therein can be reduced while reliably carrying out the image signal writing operation. Accordingly, the variation and the irregularity in the gate control voltage of the driving transistor 22 can be reduced. As a result, the irregularity in brightness among a plurality of display pixels can be reduced, and the unevenness in displaying can be suppressed.

Further, according to the present embodiment, it is constructed such that, at the time of completing the image signal writing operation, after the first switch 24 adjacent to the gate of the driving transistor 22 and the storage capacitance 28 is turned off in advance, the pixel switch 20 is switched off. Therefore, even when a feedthrough voltage is generated at the time of switching the pixel switch 20 off, the feedthrough voltage is prevented from flowing to the storage capacitance 28 side due to the first switch 24 which has been in the OFF-state in advance. Accordingly, the variation and the irregularity in the gate control voltage of the driving transistor 22 due to a feedthrough voltage can be further reduced, and the irregularity in brightness among the plurality of display pixels can be reduced. According to the above description, there can be obtained the organic EL display apparatus in which the unevenness in displaying is reduced, and the quality of displaying is improved.

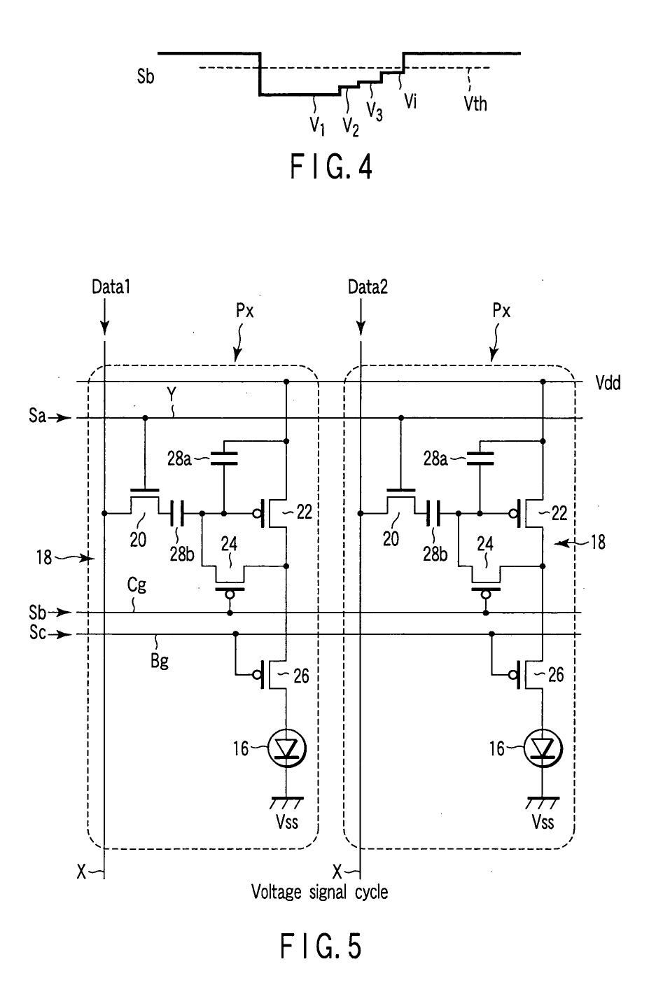

In the first embodiment described above, the ON-state electric potential of the control signal of the first switch 24 is varied in a two stepwise manner including the first and second electric potentials V1 and V2. However, as shown in FIG. 4, electric potentials V1, V2, . . . , and Vi at three or more stages may be set, and the electric potential of the control signal may be varied by multi-stages. As described above, when an attempt is made to reduce the feedthrough voltage, it is preferable that the second electric potential which is set between the first electric potential and the OFF-state electric potential of the control signal is closer to the threshold voltage within a range from the first electric potential and the threshold voltage of the first switch 24. However, due to the irregularity in the characteristic of the thin-film transistor configuring the first switch, or the like, it is difficult to set the second electric potential of a value close to the accurate threshold voltage. Then, by setting intermediate electric potentials V2, . . . , Vi whose variations are even less, at a plurality of stages, between the first electric potential and the OFF-state electric potential, at least one of those can be made to be an electric potential close to the threshold voltage.

In the embodiment described above, the timing of turning the first switch 24 off is made to be earlier than the timing of turning the pixel switch 20 off. However, the first switch and the pixel switch may be turned off at the same time. In this configuration as well, the ON-state electric potential of the control signal Sb for controlling the first switch 24 to be turned on and off is varied in a stepwise manner so as to be close to the OFF-state electric potential, whereby the effect of reduction in feedthrough voltages can be obtained, and an attempt can be made to reduce the unevenness in displaying. In this case, the first switch 24 and the pixel switch 20 may be driven by a common control signal conductor line and a common control signal.

The pixel circuit 18 of the organic EL display apparatus may be configured as, not only the electric current signal system pixel circuit, but also a voltage signal system pixel circuit. FIG. 5 illustrates display pixels PX of an organic EL display apparatus according to a second embodiment of the present invention. Each display pixel PX includes an organic EL element 16 which is a self-luminescent element, and the pixel circuit 18 for supplying a driving electric current to the organic EL element. The pixel circuit 18 is a voltage signal system pixel circuit for controlling light emission of the organic EL element 16 in accordance with an image signal formed of a voltage signal, and has a pixel switch 20, a driving transistor 22, a first switch 24, a second switch 26, and storage capacitances 28a and 28b. The driving transistor 22, the first switch 24, and the second switch 26 are configured of the same conductivity type transistors, for example, P-channel type thin-film transistors, and the pixel switch 20 is configured of an N-type thin-film transistor.

The source of the driving transistor 22 is connected to a first voltage power source Vdd. The storage capacitance 28a is connected between the gate and the source of the driving transistor 22, and the first switch 24 is connected between the gate and the drain. The gate of the driving transistor 22 is connected to the source of the pixel switch 20 via the storage capacitance 28b, and the drain of the pixel switch is connected to a signal conductor line X. The drain of the driving transistor 22 is connected to an anode of the organic EL element 16 via the second switch 26, and a cathode of the organic EL element is connected to a second voltage power source Vss.

The gate of the pixel switch 20, the gate of the first switch 24, and the gate of the second switch 26 are respectively connected to a first scanning line Y, a second scanning line Cg, and a third scanning line Bg which are provided for each row of the display pixels Px.

An image signal Data which is outputted from a signal conductor line driving circuit (not shown) and which is formed of a voltage signal is inputted to each pixel circuit 18 via the signal conductor line X. The pixel switch 20, the first switch 24, and the second switch 26 are respectively driven by control signals Sa, Sb, and Sc which have been generated at a scanning line driving circuit (not shown).

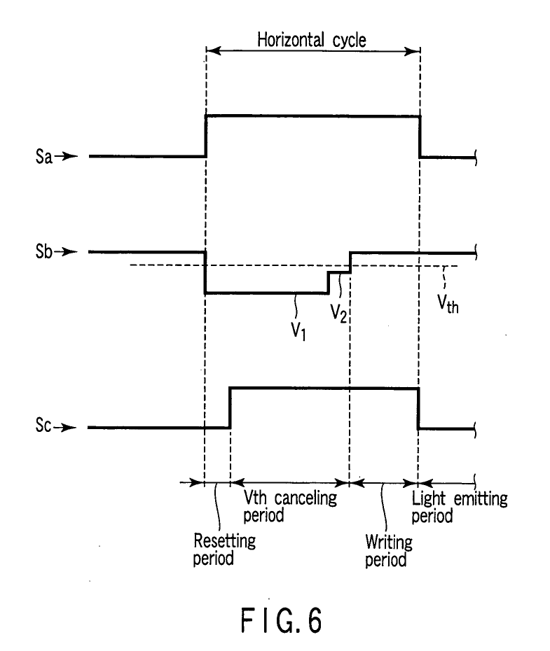

FIG. 6 illustrates a timing chart of the control signal Sa, the control signal Sb, and the control signal Sc. In the second embodiment, since the pixel switch 20 is configured of the N-channel type thin-film transistor, the polarity of the control signal Sa is inverse to the polarity of the control signal Sa in the first embodiment. The control signal Sb for controlling the first switch 24 to be turned on and off includes the first and second electric potentials V1 and V2 for maintaining the first switch in ON-state, and the electric potential varies in a stepwise manner so as to be close to the OFF-state electric potential at the time of image signal writing operation.

In the second embodiment, the other configurations are the same as those in the first embodiment described above, portions which are the same as those of the above-described embodiment are denoted by the same reference numerals, and detailed descriptions thereof will be omitted. In the second embodiment, feedthrough voltages generated at the time of turning the first switch 24 and the pixel switch 20 on and off are reduced, and an attempt can be made to improve the quality of displaying by reducing the irregularity in brightness among the display pixels.

Note that the present invention is not limited to the above-described embodiments, the components can be modified and materialized within a range which does not deviate from the gist of the present invention at the stage of implementing the invention. Further, various inventions can be formed due to the plurality of components disclosed in the above-described embodiments being appropriately combined. For example, some components may be eliminated from all of the components shown in the embodiments. Moreover, the components over the different embodiments may be appropriately combined.

In the first embodiment described above, all of the thin-film transistors constituting the pixel circuits are configured of the same conductivity type transistors, i.e., P-channel type transistors here. However, all of the thin-film transistors may be formed of the N-channel type thin-film transistors. Further, a pixel circuit can be formed by including different conductive type thin-film transistors together such that, respectively, the pixel switch and the first switch are configured of N-channel type thin-film transistors, and the driving transistor and the second switch are formed from P-channel type transistors, or the like.

Moreover, the semiconductor layer of the thin-film transistor may be formed of, not only polycrystalline silicon, but also amorphous silicon. The self-luminescent element configuring the display element is not limited to an organic EL element, and various luminescent elements which emit light itself can be applied thereto.

1. An active matrix type display apparatus comprising:
a plurality of display pixels arranged in a matrix form, each of the display pixels including a display element operating in accordance with a supplied electric current amount, a driving transistor connected to the display element in series, and a switch which is formed of a thin-film transistor and connected between a gate and a drain of the driving transistor;
a plurality of scanning lines which are provided for respective rows of the display pixels and connected to gates of the switches; and
a scanning line driving circuit which supplies a control signal that controls the switches to be turned on and off via the scanning lines, and which, when the switch is in ON-state, varies an electric potential of the control signal in a stepwise manner so as to be close to an electric potential that makes the switch be in an OFF-state.

2. An active matrix type display apparatus according to claim 1, wherein the control signal has a first electric potential and a second electric potential which make the switch be in an ON-state, and an OFF-state electric potential which makes the switch be in an OFF-state, the second electric potential is an electric potential between the first electric potential and the OFF-state electric potential, and the first and second electric potentials are electric potentials in which a voltage between the gate and a source of the switch is over a threshold voltage of the switch.

3. An active matrix type display apparatus according to claim 2, wherein the control signal maintains the second electric potential for 1 to 2 μs.

4. An active matrix type display apparatus according to claim 1, which further comprises: a plurality of signal conductor lines provided for respective columns of the display pixels; pixel switches each of which is connected between the signal conductor line and the drain of the driving transistor and each of which acquires an image signal supplied from the signal conductor line into the display pixel; and a plurality of control wirings each of which supplies a control signal that controls the pixel switch to be turned on and off independent from the switch.

5. An active matrix type display apparatus according to claim 4, wherein the control signal includes a control signal which, after making the pixel switch and the switch be in the ON-states at the same time, switches the switch to be in the OFF-state with timing earlier than the pixel switch.

6. An active matrix type display apparatus according to claim 4, wherein the control signal includes a control signal which, after making the pixel switch and the switch be in the ON-states at the same time, switches the switch to be in the OFF-state with timing of 1 μs or earlier than the pixel switch.

7. An active matrix type display apparatus according to claim 4, which further comprises a signal conductor line driving circuit which supplies the image signal formed of an electric current signal to the display pixel via the signal conductor line.

8. An active matrix type display apparatus according to claim 1, wherein the display element is the self-luminescent element which has electrodes disposed so as to face each other, and an organic emitting layer provided between the electrodes.

9. An active matrix type display apparatus according to claim 1, wherein the driving transistor and the switch are formed of thin-film transistors having semiconductor layers made of polysilicon.

10. An active matrix type display apparatus comprising:
a plurality of display pixels arranged in a matrix form;
a plurality of first, second, and third scanning lines which are respectively provided for each row of the display pixels and which are independent of one another;
a plurality of signal conductor lines provided for respective columns of the display pixels;
a scanning line driving circuit which supplies control signals to the first, second, and third scanning lines, respectively; and
a signal conductor line driving circuit which supplies an image signal formed of an electric current signal to each signal conductor line,
each of the display pixels including: a self-luminescent element which emits light in accordance with a supplied electric current amount; a pixel switch which acquires the image signal from the signal conductor line in accordance with the control signal from the first scanning line; a storage capacitance which retains a control voltage corresponding to the image signal acquired via the pixel switch; a driving transistor which is connected to the self-luminescent element in series between first and second voltage power sources and which outputs the electric current amount, which is made to flow in the self-luminescent element, in accordance with the control voltage stored by the storage capacitance; a first switch which is formed of a thin-film transistor, and which is connected between a gate and a drain of the driving transistor and is connected to the second scanning line; and a second switch connected between the drain of the driving transistor and the self-luminescent element and connected to the third scanning line, and
the scanning conductor line driving circuit being configured to supply a control signal that controls the pixel switch to be turned on and off to each first scanning line, supply a control signal that controls the second switch to be turned on and off to each third scanning line, supply a control signal that controls the first switch to be turned on and off to the second scanning line, and when the first switch is in the ON-state, vary an electric potential of the control signal for the first switch in a stepwise manner so as to be close to an electric potential that makes the first switch be in the OFF-state.
